(19) United States
(12) Patent Application Publication
(10) Pub. No.: US 2010/0257120 A1
(43) Pub. Date: Oct. 7, 2010

(54) STOCK EXCHANGE TRADING SYSTEM FOR MUTUAL FUNDS

(76) Inventor: Andrey Vyacheslavovich SHMAKOV, Moscow (RU)

Correspondence Address: ABELMAN, FRAYNE & SCHWAB, 666 THIRD AVENUE, 10TH FLOOR, NEW YORK, NY, 10017, US

(21) Appl. No.: 12/778,543

(22) Filed: May 12, 2010

Related U.S. Application Data
(63) Continuation-in-part of application No. PCT/RU2008/000144, filed on Mar. 14, 2008.
Application No. PCT/RU2008/000144 is a continuation-in-part of application No. 11/573,037, filed on Jan. 31, 2007.

(51) Int. Cl. G06Q 40/00

(52) U.S. Cl. 705/36 R

(57) ABSTRACT

The system and method of the present invention for stock exchange trading of mutual funds includes processor unit operably connected to a display device and an information input device. The processor is coupled to databases storing information regarding the quantity of shares, cash balances on trading accounts, and quantity of securities of which the property of every specified fund consists. The processor unit is operable to execute a module defining share cost connected with the unit displaying the numerical equivalent of cost of this share for each mutual fund on the display device. The module sub-modules for multiplying the quantity of securities by the accounting price, division by the quantity of fund shares the received product of the quantity of securities by accounting price, division of cash balances on trading and clearing accounts by the quantity of shares, and summation of all the division results.

### CROSS-REFERENCE TO RELATED APPLICATIONS

This application is a Continuation-in-Part under 35 USC §365(c) of international patent application number PCT/RU2008/000144, filed Mar. 14, 2008, which is incorporated herein by reference in its entirety. In addition, the present application is a Continuation-in-Part under 35 USC §120 of copending U.S. patent application Ser. No. 11/573,037, filed Jan. 31, 2007, which is a United States National stage application under 35 USC §371 of international patent application number PCT/RU2005/000317, filed on Jun. 8, 2005, both of which are incorporated by reference herein.

### BACKGROUND OF THE INVENTION

1. Field of the Invention

This invention relates to systems and methods of calculations and data processing, specially intended for specific credit and financial operations in the form of sales of shares as equivalent of securities, for example in the form of target bonds in the sphere of goods sales and service rendering.

2. Description of the Related Art

There is a prior art system of monitoring and demonstration of results of mutual funds shares purchases/sales on the stock exchange that consists of a processor unit with the relevant software connected by the communication channels with the unit that displays text and graphic information and with the information input device (RU N. 2187149, G06F17/60, published Aug. 10, 2002).

The main shortcoming of the system that is used as a tool for transactions with shares on the stock exchange is the use of algorithm of share cost calculation that lacks informativeness and accuracy. Information on the quantity of securities included into assets of mutual funds is taken from the clearing center which is represented by the Depositary Clearing Company. Information on cash balances on trading accounts comes from the clearinghouse. Data on prices of last transactions come from the stock exchange trading servers.

Information concerning the quantity of shares and balances on the mutual fund clearing accounts is prepared by a management company on the basis of data received from banks where clearing accounts are opened, and from a special depositary which considers changes in shares quantity at their purchase or redemption by shareholders. The stock exchange receives this information once a day prior to the beginning of trades and it remains unchanged throughout the trading day.

Management companies are obliged to purchase and redeem shares from shareholders only at the price calculated by the method according to which share cost is calculated in the following manner: the opening balance of securities at the beginning of day is multiplied by the weighted average price according to the results of the day; and the total sum of assets is divided by the quantity of shares. As a result, transactions with shares through the management company can be performed only at the previous day's prices, which can be deviate significantly from the actual real-time price.

The main deterrent of active mutual funds trading on the stock exchange is the absence of reliable and up-to-date information on per-share cost of mutual funds. Only with such information could professional participants of the market support bid/ask quotations of investment shares, and investors can enter into mutual fund transactions on the stock exchange. In fact, the mutual fund portfolio structure and operation of its assets is restricted information, therefore to define what happens to share cost in case of growth or drop of various shares quotations is not possible for other participants of the market. It is clear that, in view of existing normative documents of regulating authorities, a shareholder can obtain unjustified benefit or loss in relation to other shareholders at purchase or sale of shares via the management company as the price is defined with the method specified above. This fact justifies the existence of high purchase and redemption fees, so that those having insider information on actual share costs can not obtain unjustified benefits. In addition, the procedures of share purchase and redemption does not offer an opportunity to shareholders for active transactions with shares. According to current legislation the management company has a right to define the price for share redemption within 3 days after receipt of the application for redemption and then delay redemption for up to 15 days.

### BRIEF SUMMARY OF THE INVENTION

Performance of transactions with investment units via the stock exchange is capable to radically improve the situation and increase the appeal of the institution of investment funds. All that is necessary for this purpose is to define cost of property for one share on-line. If a share property consists only of stock exchange financial instruments, it is always possible to estimate its cost according to the prices of the previous transactions on the stock exchange. Taking into account the fact that the intraday quantity of shares does not vary, it is possible to estimate the property cost of one share of a mutual fund.

The present invention is intended to solve the technical problem related to input of a corresponding algorithm into a system for monitoring and displaying the stock exchange trading results to define the cost of property for one share on-line and in real-time.

Technical result achieved by the invention includes an increase of the informative value and data reliability of trading results due to the display of the real share cost based on the results of each transaction.

The above described technical result is achieved by the system and method of the present invention for stock exchange trading of mutual funds. The system includes processor unit or device connected by communication channels, e.g., suitable cables, with a text and graphic information display device and with an information input device. The processor is coupled to a database storing information regarding the quantity of shares of which every mutual fund participating in trades on the stock exchange consists, a database storing information regarding cash balances on trading accounts, and a database storing information regarding the quantity of securities of which the property of every specified fund consists. The processor unit is connected via the input device with the mentioned databases and is operable to execute a unit or module defining share cost connected with the unit displaying the numerical equivalent of cost of this share for each mutual fund on the display or as a creeping line; that is, an information, data, or news crawl-type display on the screen. At the same time the unit or module defining on-line share cost as the share price index includes a unit or sub-module for multiplying the quantity of securities included into fund property by the accounting price of this securities, a unit or sub-module for division by the quantity of fund shares the received product of the quantity of securities included into fund property by accounting price of these securities, a unit or sub-module of division of cash balances on trading and clearing accounts of the relevant mutual fund by the quantity of shares of this fund, and also a unit or sub-module for summation of all the division results. The system also has a function of defining on-line share cost in the form of a share cost index, determined by division of the sum of the product of securities included in a fund property by accounting price of these securities plus cash balances on trading and clearing accounts of the relevant mutual fund by the quantity of shares of this fund.

A creeping line is defined herein as any type of display of information, data, or news using a moving, changing, and/or crawling-type display on any portion of a display screen; for example, in a narrow line or rectangular strip or region located, for example, on the bottom of a display which simulates or evokes a traditional paper-based printed output of a stock ticker.

The specified features are essential and interconnected and form the stable complex of essential features sufficient to obtain the specified technical result.

### BRIEF DESCRIPTION OF THE SEVERAL VIEWS OF THE DRAWINGS

The present invention is explained by the specific example which, however, is not unique but visually demonstrates an opportunity of obtaining the demanded technical result with the help of given complex of features. Preferred embodiments of the invention are disclosed hereinbelow with reference to the drawings.

FIG. 1 shows the block diagram of stock exchange trading system for mutual funds.

### DETAILED DESCRIPTION OF THE INVENTION

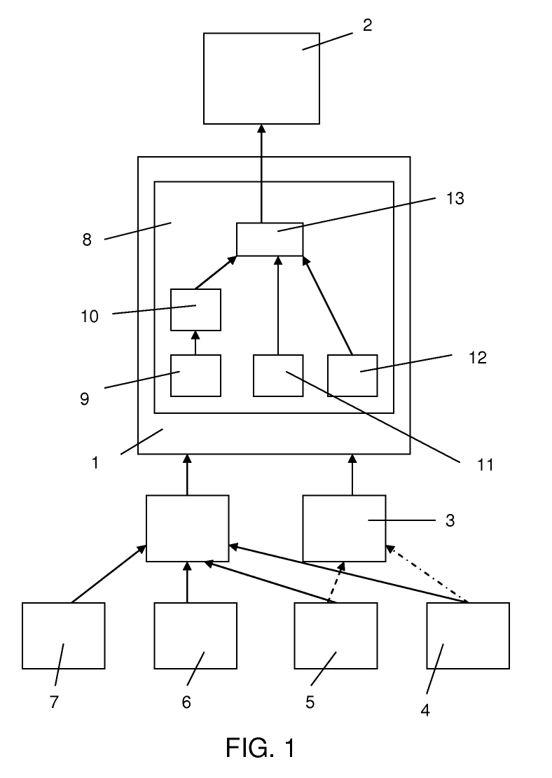

According to the invention stock exchange trading system for mutual funds as shown in FIG. 1 includes the processor unit or device 1 connected by the communication channels, e.g., cable links, with the text and graphic information display unit or device 2 that displays text and graphic information and with at least one information input device 3. The display device 2 that displays text and graphic information is presented as a display or as a creeping line.

The processor device 1, the text and graphic information display device 2 that displays and the information input device/devices represent well-known components of any computerized system. It is to be appreciated by one of ordinary skill in the art that the processor device 1 can be implemented in any computer such as a personal computer, minicomputer, workstation, mainframe, a dedicated controller such as a programmable logic controller, or a combination thereof. While the processor device 1 is shown, for illustration purposes, as a single unit, the processor device 1 can comprise a group/farm of processors or computers which can be scaled depending on the processing load and repository size.

The processor device 1 is equipped with the corresponding software for implementing the system and method disclosed herein. In addition, the processor device 1 is associated with suitable memory, for instance, including a program storage memory portion and a data storage memory portion. can each comprise volatile (RAM) and non-volatile (ROM) memory units and can also comprise hard disk and backup storage capacity. Both program storage memory and data storage memory can be embodied in a single memory device or separated in plural memory devices. Program storage memory stores software program modules and associated data, and in particular stores the software code used for system and method disclosed herein, for instance, as described with respect to module 8, and sub-modules 9, 10, 11, 12 and 13 described further herein. Data storage memory stores the databases 4, 5, 6 and 7 described further herein.

The system includes a database 4 storing information regarding the quantity of shares of which every mutual fund participating in trades on the stock exchange consists, a database 5 storing information regarding the cash balances on trading accounts, a database 6 storing information regarding the cash balances on trading accounts, and a database 7 storing information regarding the quantity of securities of which property of every specified fund consists. The processing device 1 is connected via the input device 3 with the above-mentioned databases 4, 5, 6 and 7, and is operable to execute a unit or module 8 defining share cost connected with the display unit 2 for displaying the numerical equivalent of cost of this share in real-time for each mutual fund on the display or as a creeping line. The module 8 defining on-line, real-time share cost includes a unit or sub-module 9 for multiplying the quantity of securities included into fund property by accounting price of this securities, a unit or sub-module 10 for division by the quantity of fund shares the received product of the quantity of securities included into fund property by accounting price of these securities, a unit or sub-module 11 for division of cash balances on trading accounts of the relevant mutual fund by the quantity of shares of this fund, a unit or sub-module 12 for division of clearing accounts of the relevant mutual fund by the quantity of shares of this fund, and also a unit or sub-module 13 for summation of all the division results of product of quantity of securities included into the fund property with the results received in units or sub-modules of division.

The module 8 of share cost calculation with the specified software has the function of share cost defining on-line and displaying of the numerical equivalent of cost of this share for each mutual fund on the display device 2 or as a creeping line in the form of the share cost index calculated, dividing by the quantity of fund shares the received product of the quantity of securities included into fund property by accounting price of these securities plus the cash balances on trading and clearing accounts of the relevant mutual fund.

An exemplary share cost calculation is as follows:

1. Prior to the beginning of trades the stock exchange receives from the management company the information in the form of:

a. extracted information as to the quantity of shares included into the fund; and

b. extracted information as to balances on mutual fund clearing accounts. This data remains unchanged throughout the day. All quantity of shares changes in the case of redemption or sale of shares will be made after closing of trades.

2. The stock exchange has the information on the quantity of securities and cash balances on trading accounts included into the fund property on-line.

3. As the accounting price, which is the basis for securities cost, determination is taken as the price of last transaction. If within the day any security did not take part in the transactions then the closing price of the previous day is used.

4. Net asset value (NAV) of mutual fund is determined as the sum of product of quantity of securities on accounting price, plus cash balances on trading and clearing accounts.

5. Cost of mutual fund property for one share is determined by dividing NAV by the quantity of shares.

Updating of information takes place in case of transaction with fund assets or in case if the price of last transaction on securities of the issuer included into the mutual fund investment portfolio changes. This value in the form of share price index is transmitted at stock exchange in the same way as stock indices are.

The share price (cost) index Iₜ on an estimated time is calculated as the ratio of cumulative market value Sₜ of net mutual fund assets at the present time to the quantity of shares Nₜ: Iₜ=Sₜ/Nₜ, where

$${S}_{t} = {\sum }_{i = 0}^{N} {P}_{i} * {Q}_{i} + {M}_{D} + {M}_{r}$$

in which

Qᵢ is the quantity of i-th type securities belonging to mutual fund at the present moment;

Pᵢ is the price of i-th security for an estimated time;

M_{b} is the cash balance of mutual fund on trading account in stock exchange trading system;

Mᵣ is the total cash balances of mutual fund on its clearing accounts adjusted according to value of receivable and payable accounts;

N is the number of securities type in the mutual fund investment portfolio.

If during the current trading session the transactions on these securities were carried out, then as Pᵢ for the i^{th} security is taken as the price of the last transaction; if transactions on these securities during the current trading session were not carried out, then as Pᵢ for i^{th} security is taken the closing price of the previous day.

The market of polled investments in Russia in recent years has shown high growth dynamic, however, shareholders had the opportunities to receive the information on cost of net assets and share only after the ending of trading session. The present invention will allow share pricing to be made more transparent: the indicator of share cost will allow investors to trace its dynamics during the trading day and operatively make decisions on sale or purchase of shares. Calculation of this indicator will contribute to popularization and growth of liquidity of the secondary market of the given tools.

The present invention is exercisable as it can be realized with use of widely applicable computerized systems and corresponding software, that can process the entered data according to the incorporated algorithm according to the formula given in the description.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A stock exchange trading system for mutual funds comprising:
a text and graphic information display device having a screen or a creeping line display;
a data input device; and
a processing device having at least one processor which is coupled to memory for storing software programs, said software programs being executable by said at least one processor, said processing device communicably connected via cable links with the text and graphic information display device and the data input device, the processing unit being operable to:
receive data, via the input device, and provide storage of database information
regarding the quantity of shares of which every mutual fund participating in trades on the stock exchange consists,
regarding the cash balances on trading accounts,
regarding the cash balances on trading accounts, and
regarding the quantity of securities of which property of every specified fund consists; and
provide, in real-time, a numerical equivalent of the cost of shares for each mutual fund, for display on the a text and graphic information display device, wherein the cost of shares information is computed as
the summation of
the division by the quantity of fund shares the product of the quantity of securities included into fund property by accounting price of these securities and
the division of cash balances on trading and clearing accounts of the relevant mutual fund by the quantity of shares of this fund.
